(19) United States
(12) Patent Application Publication
(10) Pub. No.: US 2004/0070505 A1
(43) Pub. Date: Apr. 15, 2004

(54) Number plate authentication device

(76) Inventors: Guy Pluvinage, Fontenay aux Roses (FR); Jean-Henry De Beaucorps, Versailles (FR)

Correspondence Address: JACOBSON HOLMAN PLLC, 400 SEVENTH STREET N.W., SUITE 600, WASHINGTON, DC, 20004, US

(21) Appl. No.: 10/467,070

(22) PCT Filed: Feb. 26, 2002
(86) PCT No.: PCT/FR02/00698

(30) Foreign Application Priority Data
Feb. 26, 2001 (FR) 01/02591

(51) Int. Cl. G08B 13/14

(52) U.S. Cl. 340/572.8; 340/5.8; 235/384

(57) ABSTRACT

The invention relates to a vehicle number plate (1) authentication device, characterized in that it comprises a support element (2) which can be fixed to and/or integrated into the number plate (1). Said support element (2) comprises information relating to the vehicle and/or the use of said vehicle which can be read using reading means (3).

The present invention relates to a device for authenticating the number plates of vehicles.

In order to be identified, virtually all vehicles must be equipped with one or two number plates (or registration plates) comprising a series of figures and of letters, called registration number.

Plates of known type are generally made of metal, the registration number being printed on said plate by an operation of embossing.

However, these plates, whose characteristics are imposed by legislation, are easily falsifiable, and inspection by authorized personnel is tedious.

In effect, the inspector (police officer, customs officer, vehicle registration agent . . . ) must note down the plate of a vehicle and check, with a central file, whether the plate indeed corresponds to the vehicle on which it is affixed.

This checking operation is long and complex since it calls upon different participants as well as a centralized file remote from the places where the check is made.

In this context, the present invention overcomes the drawbacks of the prior art by proposing a device making it possible to authenticate the registration plates affixed on vehicles of all kinds, in easy and rapid manner.

To that end, according to the invention, the device for authenticating a vehicle number plate is characterized in that it comprises a support element which can be fixed to and/or integrated into said number plate, said support element comprising information relating to the vehicle and/or the use of said vehicle, which can be read using reading means.

The support element is advantageously an electronic label comprising an integrated circuit connected to an antenna.

The electronic label preferably also presents protection means comprising a foil of non-conducting plastics material such as polycarbonate.

According to a preferred form of embodiment, the electronic label presents insulation means comprising a foil of insulating material, shaped so as to render the fixation of the support element on the number plate non-removable without provoking alteration of said support element.

According to the embodiment, the integrated circuit is of the Read-Only type or of Read-Write type.

The invention also concerns a number plate, characterized in that it comprises an authentication device according to the invention, as well as an assembly constituted by a device according to the invention associated with reading means of the portable reader type.

The portable reader advantageously comprises an antenna as well as electronic management means.

The invention will be more readily understood on reading the following description relating to an illustrative but in no way limiting example of embodiment, with reference to the accompanying drawings, in which:

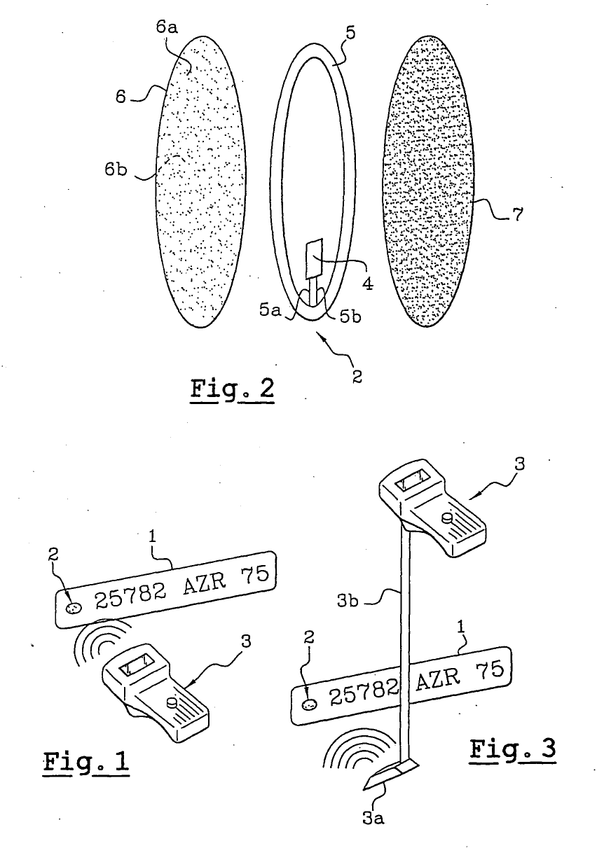

FIG. 1 is an overall view of the device according to the invention for authenticating number plates.

FIG. 2 is an exploded, detailed view of the invention, in perspective.

FIG. 3 is a view of a variant embodiment of the reading means of the invention.

In the following description, the term number plate or registration plate is understood to mean a substantially square or rectangular plate comprising a registration number stuck or embossed on said plate and equipping, in known manner, all types of vehicle such as truck, automobile, motor-bike, etc. As a general rule, and this is the case envisaged here, the number plates are made of metal.

FIG. 1 shows in perspective a number plate 1 equipped with an authentication device 2 according to the invention.

Said authentication device 2 comprises a support element such as an electronic label which may be fixed to or integrated into the number plate 1 either during or after manufacture of said number plate 1.

The electronic label 2 is adapted to contain information relating to the vehicle equipped with the number plate 1 and/or to the use of said vehicle.

The information stored on the support element 2 is adapted to be read by reading means constituted, for example, by a portable reader 3 whose functioning will be described hereinbelow.

FIG. 2 shows, in an exploded perspective view, the electronic label 2 of the invention.

Said electronic label 2, of substantially circular shape, comprises information storage means 4 coupled to emission-reception means 5, included between, on one side, insulation and fixation means 6 and, on the other side, protection means 7.

The information storage means 4 are constituted by an integrated circuit, commonly called chip, of the wired logic type, used in the technique of transponders.

According to a first form of embodiment, the chip 4 is of the Read-Only type, the identification number of the chip 4 being engraved, for example, by laser fusion during its manufacture. This identification number of the chip 4 thus guarantees its unique nature.

The memory capacity of the chip 4 (64 bits for example for Read-Only), allows it to store a certain amount of information which can identify the number plate 1 as well as the corresponding vehicle. This information may for example be the make and type of vehicle, as well as its serial number.

According to a second form of embodiment, the chip 4 is of the Read-Write type, designed in accordance with EEPROM technology and having a memory capacity of 900 bits.

This memory capacity makes it possible to enter a larger amount of information in order to identify and authenticate the number plate 1 as well as the corresponding vehicle.

This additional information may for example be the designated driver of the vehicle or data relative to the technical state of said vehicle.

The process of reading and/or writing of the data of the chip 4 will be seen hereinbelow, in connection with FIG. 3.

The chip 4 is connected, via two connections 5a, 5b, to an antenna 5 presenting a substantially annular shape with a diameter of about 30 mm for example, the chip 4 being disposed inside the ring defined by said antenna 5.

The electronic label 2 further comprises insulation and fixation means 6 in the form of a disc whose diameter is substantially equivalent to that of the antenna 5.

These insulation and fixation means are made with the aid of a foil of insulating material comprising two adhesive faces so as to be able to stick the chip 4 as well as the antenna 5 on one of the faces 6a of the insulation foil 6, the second face 6b of the insulation foil 6 being stuck on the number plate 1.

The insulation and fixation foil 6 is shaped so as to bring about alteration of the electronic label in the case of it being torn from the number plate 1.

In effect, it is possible to provide, for example, for the tearing of the electronic label 2 to bring about destruction of the connections 5a, 5b linking the chip 4 to the antenna 5, rendering said electronic label 2 unusable.

Protection means 7 are also provided in order to cover the chip 4 coupled to the antenna 5 and disposed on the face 6a of the insulation and fixation foil 6.

Said protection means 7 are constituted by a disc whose shape is substantially complementary of that of the insulation and fixation foil 6, and made of a non-conducting material such as polycarbonate.

FIG. 3 shows a variant embodiment of the reading means 3.

In effect, said portable reader 3 presents an antenna 3a offset with the aid of an arm 3b in order to facilitate inspection of the number plate 1, thus avoiding the inspector having to stoop.

The electronic label 2 is passive, i.e. it does not necessitate internal supply. It is supplied with energy solely via the reader 3 when the latter is brought near the electronic label 2.

In effect, the supply as well as the transmission of the information is effected by magnetic coupling between the electronic label 2 and the portable reader 3, via their respective antennas 5 and 3a.

Such supply and transmission operations are for example carried out at a radio frequency of 125 KHz which makes it possible to overcome the constraints created by the presence of metal on the number plate 1 and on the vehicle to be inspected, itself.

In this way, the communication via low frequencies between the electronic label 2 and the portable reader 3, both set at identical frequencies, allows the transmission of data between its two elements.

In Read-Only mode, the electronic label 2 transmits the information that it contains to the portable reader 3 by modulation of the amplitude of the electromagnetic field permanently emitted by said portable reader 3.

In Write mode, the modulation of the amplitude of the electromagnetic field is effected by the portable reader 3 itself, at a rate different from that used in Read mode.

It is thus possible to add a certain amount of information to that already contained in the memory zone of the chip 4, for example depending on the life cycle of the vehicle equipped with the number plate 1.

The portable reader 3 presents, in addition to the antenna 3a, electronic management means incorporating microprocessor, adapted to analyze, read and/or send information in the direction of the electronic label 2.

The portable reader 3 also comprises, in known manner, means for displaying the read information coming from the electronic label 2.

According to a particular form of embodiment, the portable reader 3 comprises means for linking with a remote data base listing, for example, sought-for vehicles (stolen vehicles, etc.). These linking means may be of telegraphic, radio, infrared or like type, and may function permanently or intermittently.

The portable reader 3 may also comprise its own data base listing certain vehicles, for example those sought in priority.

The present invention thus makes it possible to authenticate, in reliable, rapid and easy manner for the inspectors, the number plates equipping any type of vehicles, while allowing said inspectors to have access to a large amount of information concerning said vehicle and/or its use.

1. Device for authenticating a vehicle number plate (1) comprising a support element (2) which can be fixed to and/or integrated into said number plate (1), said support element (2) comprising information relating to the vehicle and/or to the use of said vehicle, adapted to be read by reading means (3), characterized in that the support element (2) is an electronic label comprising insulation means (6) making it possible to fix said electronic label on the number plate (1).

2. Device according to claim 1, characterized in that the insulation means (6) are shaped so as to render the fixation of the electronic label (2) on the number plate (1) non-removable without bringing about the alteration of said electronic label (2).

3. Device according to claim 1 or 2, characterized in that the insulation means (6) comprise a foil of insulating material.

4. Device according to claim 3, characterized in that the foil of insulating material comprises two adhesive faces (6a, 6b).

5. Device according to one of claims 1 to 4, characterized in that the electronic label (2) comprises protection means (7).

6. Device according to the preceding claim, characterized in that the protection means (7) comprise a protection foil made of non-conducting material.

7. Device according to the preceding claim, characterized in that the protection sheet (7) is made of polycarbonate.

8. Device according to one of claims 1 to 7, characterized in that the electronic label (2) comprises an integrated circuit (4) connected to an antenna (5).

9. Device according to claim 8, characterized in that the integrated circuit (4) is of the Read-Only type.

10. Device according to claim 8, characterized in that the integrated circuit (4) is of the Read/Write type.

11. Number plate, characterized in that it comprises an authentication device according to one of claims 1 to 10.

12. Assembly constituted by an authentication device according to one of Clams 1 to 10 associated with reading means (3) of the portable reader type.

13. Assembly according to the preceding claim, characterized in that the portable reader (3) comprises an antenna (3a) as well as electronic management means.
